(19) United States
(12) Patent Application Publication
(10) Pub. No.: US 2026/0194190 A1
(43) Pub. Date: Jul. 9, 2026

(54) REMAINING AMOUNT ESTIMATION METHOD FOR HYDROGEN TANK, REMAINING AMOUNT ESTIMATION DEVICE FOR HYDROGEN TANK, AND POWER GENERATION SYSTEM

(71) Applicant: Panasonic Intellectual Property Management Co., Ltd., Osaka (JP)

(72) Inventors: TAKEHIKO ISE, Osaka (JP); YASUSHI KANEKO, Osaka (JP); YOSHIFUMI TAGUCHI, Osaka (JP); YOSHIKAZU TANAKA, Tokyo (JP); YASUMICHI YOSHIHARA, Osaka (JP); TSUTOMU FUJII, Osaka (JP); MIKI ABE, Hokkaido (JP)

(21) Appl. No.: 19/553,896

(22) Filed: Mar. 2, 2026

Related U.S. Application Data
(63) Continuation of application No. PCT/JP2024/027071, filed on Jul. 30, 2024.

(30) Foreign Application Priority Data
Sep. 13, 2023 (JP) 2023-148250

(51) Int. Cl. F17C 13/02

(52) U.S. Cl. CPC F17C 13/02; F17C 2221/012; F17C 2250/0408; F17C 2250/0473; F17C 2270/0763

(57) ABSTRACT

A remaining amount estimation method for a hydrogen tank used in a fuel cell device including at least one fuel cell unit includes estimating a time when the remaining amount of hydrogen in a hydrogen tank falls to a first threshold value or below based on a used amount of hydrogen in the hydrogen tank during a first time period of a plurality of consecutive days and notifying a display device of the time. When a used amount of hydrogen in the hydrogen tank during a second time period of a plurality of consecutive days within the first time period is less than or equal to a second threshold value, the time is estimated based on a used amount of hydrogen in the hydrogen tank during the first time period excluding the second time period.

### BACKGROUND

### 1. Technical Field

The present disclosure relates to a remaining amount estimation method for a hydrogen tank, a remaining amount estimation device for a hydrogen tank, and a power generation system.

### 2. Description of the Related Art

International Publication No. 2020/203520 discloses a device for generating an operation plan for a hydrogen production system including a hydrogen generation device. The hydrogen production system includes a demand prediction unit that generates predicted demand levels for a plurality of types of hydrogen, each having a different environmental burden in production thereof, over a target period of the operation plan and an operation planning unit that generates an operation plan for generating the plurality of types of hydrogen having different environmental burdens in production thereof by using the hydrogen generation device on the basis of the respective predicted hydrogen demands for the plurality of types of hydrogen.

### SUMMARY

One non-limiting and exemplary embodiment provides, as an example, a remaining amount estimation method for a hydrogen tank, a remaining amount estimation device for a hydrogen tank, and a power generation system that can estimate the time when the remaining amount of hydrogen in the hydrogen tank used in a fuel cell device falls to a predetermined amount or below more accurately than existing ones.

In one general aspect, the techniques disclosed here feature a remaining amount estimation method for a hydrogen tank used in a fuel cell device including at least one fuel cell unit. The method includes estimating a time when a remaining amount of hydrogen in a hydrogen tank falls to a first threshold value or below based on a used amount of hydrogen in the hydrogen tank during a first time period of a plurality of consecutive days and notifying a display device of the time. When a used amount of hydrogen in the hydrogen tank during a second time period of a plurality of consecutive days within the first time period is less than or equal to a second threshold value, the time is estimated based on a used amount of hydrogen in the hydrogen tank during the first time period excluding the second time period.

According to the aspect of the present disclosure, the remaining amount estimation method for a hydrogen tank, the remaining amount estimation device for a hydrogen tank, and the power generation system can provide the effect of estimating the time when the remaining amount of hydrogen in a hydrogen tank used in a fuel cell device falls to a predetermined amount or below more accurately than existing ones.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates an example of a power generation system according to a first embodiment;

FIG. 2A illustrates an example of a sensor for calculating the remaining amount of hydrogen in a hydrogen tank;

FIG. 2B illustrates an example of a sensor for calculating the remaining amount of hydrogen in a hydrogen tank;

FIG. 2C illustrates an example of a sensor for calculating the remaining amount of hydrogen in a hydrogen tank;

FIG. 3 is a flowchart illustrating an example of the operation performed by a remaining amount estimation device for a hydrogen tank (a remaining amount estimation method for a hydrogen tank) according to the first embodiment;

FIG. 4 is a flowchart illustrating an example of the operation performed by a remaining amount estimation device for a hydrogen tank (a remaining amount estimation method for a hydrogen tank) according to the first example of the first embodiment; and

FIG. 5 illustrates an example of a power generation system according to a second embodiment.

### DETAILED DESCRIPTIONS

The present inventors have studied estimation of the time when the remaining amount of hydrogen in a hydrogen tank used in the fuel cell device falls to a predetermined threshold value or below. As a result of the study, the present inventors have found that if the data acquired in several consecutive days in which the hydrogen usage of the hydrogen tank is irregularly lower than the normal hydrogen usage is excluded from the calculation of hydrogen usage of the hydrogen tank, the hydrogen usage can be calculated more properly than when the data is included. As such, the present disclosers have conceived of an aspect of the present disclosure described below.

That is, a first aspect of the present disclosure provides a remaining amount estimation method for a hydrogen tank used in a fuel cell device including at least one fuel cell unit. The method includes estimating the time when the remaining amount of hydrogen in the hydrogen tank falls to a first threshold value or below based on the used amount of hydrogen in the hydrogen tank during a first time period of a plurality of consecutive days and notifying a display device of the time. If the used amount of hydrogen in the hydrogen tank during a second time period of a plurality of consecutive days within the first time period is less than or equal to a second threshold value, the above-described time is estimated based on the used amount of hydrogen in the hydrogen tank during the first time period excluding the second time period.

According to the above description, the remaining amount estimation method for a hydrogen tank of the present aspect can estimate the time when the remaining amount of hydrogen in a hydrogen tank used in a fuel cell device falls to a first threshold value or below more accurately than existing methods.

More specifically, excluding, from the calculation of hydrogen usage, data obtained during the second time period during which the hydrogen usage of the hydrogen tank is irregularly low as compared with normal hydrogen usage over a plurality of days can result in a more appropriate calculation of hydrogen usage than when the data is not excluded. Therefore, according to the remaining amount estimation method for a hydrogen tank of the present aspect, by estimating the time when the remaining amount of hydrogen in the hydrogen tank falls to the first threshold value or below based on the used amount of hydrogen in the hydrogen tank during the first time period excluding the second time period, the accuracy of the estimation can be improved as compared with the case where such excluded period is not provided in calculation of hydrogen usage. This allows the user to refill the hydrogen tank with hydrogen or replace the hydrogen tank in use with a new hydrogen tank in a timely manner.

In addition, according to the remaining amount estimation method for a hydrogen tank of the present aspect, by setting each of the first time period and the second time period to a plurality of consecutive days, estimation of the time when the remaining amount of hydrogen in a hydrogen tank falls to the first threshold value or below is less affected by fluctuation in hydrogen usage in daily activities. For example, in general, hydrogen usage on a specific day, such as a holiday, is lower than that on a weekday. According to the remaining amount estimation method for a hydrogen tank of the present aspect, by setting the first time period and the second time period in the above-described manner, the influence of fluctuation in daily hydrogen usage is reduced in the estimation of the time when the remaining amount of hydrogen in a hydrogen tank falls to the first threshold value or below.

According to a remaining amount estimation method for a hydrogen tank of a second aspect of the present disclosure, when the first time period is the same as the second time period in the remaining amount estimation method for a hydrogen tank of the first aspect, it is not needed to update the time when the remaining amount of hydrogen in a hydrogen tank falls to the first threshold value or below.

The statement “the first time period and the second time period are the same” herein means that the hydrogen usage of the hydrogen tank is irregularly less than the normal hydrogen usage during the entire first time period. Therefore, according to the remaining amount estimation method for a hydrogen tank of the present aspect, by not updating the time when the remaining amount of hydrogen in a hydrogen tank used in a fuel cell device falls to the first threshold value or below if the first time period and the second time period are the same, the time estimating operation can be performed more efficiently.

According to a remaining amount estimation method for a hydrogen tank of a third aspect of the present disclosure, in the remaining amount estimation method for a hydrogen tank of the first aspect or second aspect, the time when the remaining amount of hydrogen in a hydrogen tank falls to the first threshold value or below may be estimated based on the value obtained by dividing the difference between the remaining amount of hydrogen in the hydrogen tank and the first threshold value by the average daily amount of hydrogen used during the first time period excluding the second time period.

According to the above description, by estimating the time when the remaining amount of hydrogen in a hydrogen tank falls to the first threshold value or below based on the value obtained by dividing the difference between the remaining amount of hydrogen in the hydrogen tank and the first threshold value by the average daily amount of hydrogen used during the first time period excluding the second time period, the remaining amount estimation method for a hydrogen tank of the present aspect can improve the accuracy of the estimation as compared with the case where no such excluded time period is applied to the calculation of hydrogen usage.

According to a remaining amount estimation method for a hydrogen tank of a fourth aspect of the present disclosure, in the remaining amount estimation method for a hydrogen tank of any one of the first to third aspects, the first time period may be one or more weeks, and the second time period may be a week (or weeks) less than or equal to the first time period.

According to the above description, in the remaining amount estimation method for a hydrogen tank of the present aspect, by setting the first time period and the second time period to one or more weeks and a week (or weeks) less than or equal to the first time period, respectively, estimation of the time when the remaining amount of hydrogen in a hydrogen tank falls to the first threshold value or below is less affected by fluctuations in the hydrogen usage in daily activities. For example, in general, the amount of hydrogen used during a specific time period in a week (for example, a weekend, such as Saturday and Sunday) is lower than that during a weekday. According to the remaining amount estimation method for a hydrogen tank of the present aspect, by setting the first time period and the second time period as described above, the influence of fluctuations in daily hydrogen usage that are repeated weekly can be reduced in estimation of the time when the remaining amount of hydrogen in a hydrogen tank falls to the first threshold value or below.

According to a fifth aspect of the present disclosure, a remaining amount estimation device for a hydrogen tank used in a fuel cell device including at least one fuel cell unit includes a controller that estimates a time when the remaining amount of hydrogen in the hydrogen tank falls to a first threshold value or below based on a used amount of hydrogen in the hydrogen tank during a first time period of a plurality of consecutive days and a communicator that is controlled by the controller and that notifies a display device of the time. When a used amount of hydrogen in the hydrogen tank during a second time period of a plurality of consecutive days within the first time period is less than or equal to a second threshold value, the controller estimates the time based on a used amount of hydrogen in the hydrogen tank during the first time period excluding the second time period.

According to the above description, the remaining amount estimation device for a hydrogen tank of the present aspect can estimate the time when the remaining amount of hydrogen in a hydrogen tank used in the fuel cell device falls to the first threshold value or below more accurately than existing ones. Detailed description of the operation and effects of the remaining amount estimation device for a hydrogen tank of the present aspect is the same as that for the remaining amount estimation method for a hydrogen tank of the first aspect and, therefore, the detailed description is omitted.

A power generation system according to a sixth aspect of the present disclosure includes a fuel cell device that includes at least one fuel cell unit and the remaining amount estimation device for a hydrogen tank according to the fifth aspect.

According to the above description, the power generation system of the present aspect can estimate the time when the remaining amount of hydrogen in a hydrogen tank used in a fuel cell device falls to a first threshold value or below more accurately than existing ones. Detailed description of the operation and effects of the power generation system of the present aspect is the same as that for the remaining amount estimation method for a hydrogen tank of the first aspect and, therefore, the detailed description is omitted.

Particular examples according to the above-described aspects of the present disclosure are described below with reference to the accompanying drawings. The particular examples described below are all examples according to the above-described aspects of the present disclosure. Therefore, a shape, a value, a constituent element, the positions and the connection form of the constituent elements, and the like described below shall not be construed as limiting the scope of the claims, unless otherwise stated in the claims.

In addition, among the constituent elements described below, the constituent element that does not appear in an independent claim, which has the broadest scope of the present disclosure, is described as an optional constituent element. In addition, in the drawings, those identified by the same reference numeral may be omitted from the description. For ease of understanding of the drawings, the constituent elements are schematically illustrated and may not be exact representations in terms of shape and dimensional ratio.

Furthermore, the order of the processes may be rearranged as necessary, or a well known process may be added.

### First Embodiment

### Device Configuration

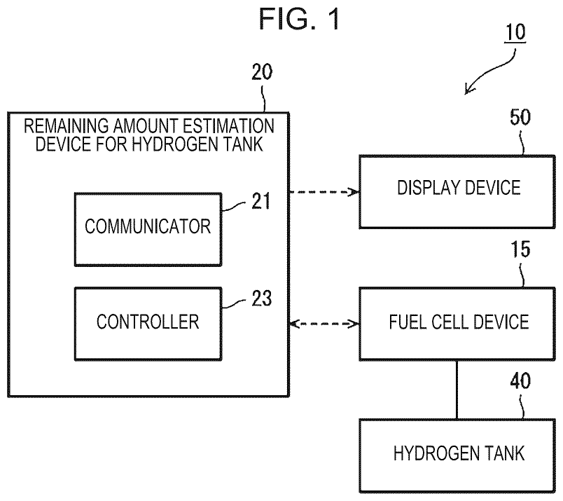

FIG. 1 illustrates an example of a power generation system according to the first embodiment.

As illustrated in FIG. 1, a power generation system 10 includes a fuel cell device 15 and a remaining amount estimation device 20 for a hydrogen tank 40 used in the fuel cell device 15.

The fuel cell device 15 includes at least one fuel cell unit that generates electric power by using hydrogen from a hydrogen tank 40. Thus, the fuel cell device 15 may include a single fuel cell unit or a plurality of fuel cell units. In the latter case, the power generation system 10 may be, for example, a system that supplies a large amount of power to an electric power system. That is, in the latter case, the power generation system 10 include a fuel cell unit group consisting of a plurality of fuel cell units including fuel cell stacks, and the fuel cell device 15 correspond to each of the groups obtained by dividing the fuel cell unit group. The detailed configuration of the power generation system 10 is described in a second embodiment.

As illustrated in FIG. 1, the remaining amount estimation device 20 for the hydrogen tank 40 includes a communicator 21 and a controller 23.

The controller 23 estimates the time when the remaining amount of hydrogen in the hydrogen tank 40 falls to a threshold value SA or below based on the used amount of hydrogen in the hydrogen tank 40 during a time period A of a plurality of days. When the used amount of hydrogen in the hydrogen tank during a time period B of a plurality of days within the time period A is less than or equal to a threshold value SB, the controller 23 estimates the time when the remaining amount of hydrogen in the hydrogen tank 40 falls to the threshold value SA or below based on the used amount of hydrogen in the hydrogen tank during the time period A excluding the time period B. A particular example of a method for calculating the “time when the remaining amount of hydrogen in the hydrogen tank 40 falls to the threshold value SA or below” is described in a first example.

The “plurality of days” of the “time period A” may be several days or an appropriate number of days that are longer than the several days and that are selected from one week (seven days) to several months. For example, the “period A” may be weeks selected from about two weeks to about one month (four weeks).

The “plurality of days” of the “time period B” may be a several days or an appropriate number of days that are longer than the several days and that are selected from one week (seven days) to one month. For example, the “time period B” may be one week (seven days), but needs to be at least shorter than or equal to the “time period A”.

The “threshold value SA” is an appropriate amount of hydrogen that is determined in advance by a user and corresponds to a reference value used to prompt the user to refill the hydrogen tank 40 with hydrogen or exchange the hydrogen tank 40 in use with a new one when the remaining amount of hydrogen in the hydrogen tank 40 becomes low. The “threshold value SA” may be set to, for example, an amount corresponding to about 20% of the amount of hydrogen fully stored in the hydrogen tank 40. However, the “threshold value SA” is not limited thereto.

The “threshold value SB” is an appropriate amount of hydrogen that is determined in advance by the user and corresponds to a reference value determined on the assumption of a situation in which the hydrogen usage of the hydrogen tank 40 during the time period B is irregularly low as compared with the normal hydrogen usage. The “threshold value SB” may be set to, for example, an amount corresponding to about 10% of the amount of hydrogen fully stored in the hydrogen tank 40. However, the “threshold value SB” is not limited thereto.

The “situation in which the hydrogen usage of the hydrogen tank during the time period B is irregularly low as compared with the normal hydrogen usage” occurs due to a variety of factors. For example, the above situation may occur due to some unusual action taken by the user. The above situation may also occur, for example, due to the hydrogen usage of the hydrogen tank 40 not being measured properly. The above situation may also occur, for example, due to the inability of the power generation system 10 to generate electric power properly.

The above-described situations do not include a case where the operation performed by the power generation system 10 is regularly suspended for a plurality of days, because, as described above, the situation occurs when the hydrogen usage is irregularly low as compared with the normal hydrogen usage. For example, the case where the operation performed by the power generation system 10 is suspended every Saturday and Sunday is not included in the above-described situation. In such a case, the time period B is set to a period that includes the suspension period and that is longer than the suspension period (for example, one week), and the threshold value SB is set to determine whether the above-described situation occurs with respect to the time period B.

Any controller having a control function can be used as the controller 23. The controller 23 includes an arithmetic processing unit (not illustrated) and a storage unit that stores a control program. The arithmetic processing unit reads and executes the control program stored in the storage unit and, thus, performs predetermined control in the controller 23. For example, a microprocessor is used as the arithmetic processing unit. For example, a memory is used as the storage unit. The controller 23 may directly control the operation including the output of the fuel cell unit in the fuel cell device 15. If the fuel cell unit includes a control unit (not illustrated) that controls the operation performed by the fuel cell unit, the controller 23 may indirectly control the operation including the output of the fuel cell unit in the fuel cell device 15 via the control unit.

The communicator 21 is a transmitter that, under the control of the controller 23, notifies a display device 50 of information regarding when the remaining amount of hydrogen in the hydrogen tank 40 falls to the threshold value SA or below. For example, a user information terminal that receives a service of supplying electric power generated by the power generation system 10 can be the display device 50. However, the display device 50 is not limited thereto.

The remaining amount of hydrogen in the hydrogen tank 40 may be measured by, for example, a suitable sensor. The arithmetic processing unit of the controller 23 performs the measurement at a predetermined time intervals by using the sensor, and the measurement data of the sensor is sequentially stored in the storage unit of the controller 23. The “predetermined time interval” may be, but not limited to, about 30 seconds, for example.

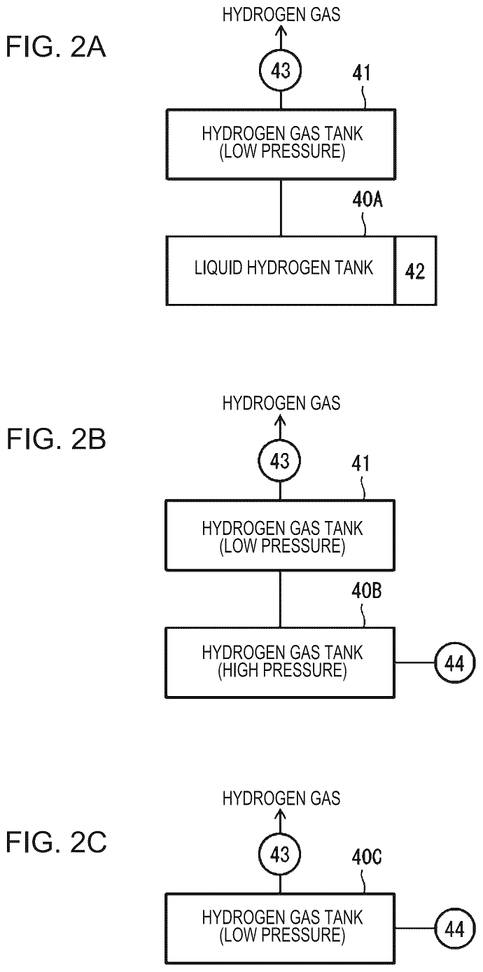

For example, as illustrated in FIG. 2A, in some cases, a liquid hydrogen tank 40A for hydrogen refill and a hydrogen gas tank 41 for storing, in the form of low-pressure hydrogen gas, the liquid hydrogen in the liquid hydrogen tank 40A are provided as a hydrogen supply source for the fuel cell device 15. In this case, since the liquid hydrogen tank 40A corresponds to a “hydrogen tank” of the present disclosure, the remaining amount of hydrogen in the liquid hydrogen tank 40A may be calculated by the controller 23 from, for example, the measurement data of a liquid level sensor 42 provided in the liquid hydrogen tank 40A. Alternatively, the remaining amount of hydrogen in the liquid hydrogen tank 40A may be calculated by the controller 23 from the measurement data of a flowmeter 43 provided in a hydrogen gas path for supplying hydrogen gas from the hydrogen gas tank 41 to the fuel cell device 15. The measurement data of the liquid level sensor 42 or the flowmeter 43 may be transmitted to the controller 23 via a controller (not illustrated) provided in the fuel cell device 15 or may be transmitted directly to the controller 23. The controller (not illustrated) provided in the fuel cell device 15 corresponds to a control unit 30A or the like described below.

As illustrated in FIG. 2B, in some cases, a hydrogen gas tank 40B that stores high-pressure hydrogen gas for hydrogen refill and the hydrogen gas tank 41 that stores, in the form of low-pressure hydrogen gas, the high-pressure hydrogen gas in the hydrogen gas tank 40B are provided as a hydrogen supply source for the fuel cell device 15. In this case, since the hydrogen gas tank 40B corresponds to the “hydrogen tank” of the present disclosure, the remaining amount of hydrogen in hydrogen gas tank 40B may be calculated by the controller 23 from the measurement data of a pressure meter 44 provided in the hydrogen gas tank 40B, for example. Alternatively, the remaining amount of hydrogen in hydrogen gas tank 40B may be calculated by the controller 23 from the measurement data of the flowmeter 43 provided in a hydrogen gas path for supplying hydrogen gas from the hydrogen gas tank 41 to the fuel cell device 15. The measurement data of the pressure meter 44 or the flowmeter 43 may be transmitted to the controller 23 via a controller (not illustrated) provided in the fuel cell device 15 or may be transmitted directly to the controller 23. The controller (not illustrated) provided in the fuel cell device 15 corresponds to the control unit 30A or the like described below.

As illustrated in FIG. 2C, in some cases, a hydrogen gas tank 40C that stores low-pressure hydrogen gas for hydrogen refill may be provided as a hydrogen supply source for the fuel cell device 15. In this case, since the hydrogen gas tank 40C corresponds to the “hydrogen tank” of the present disclosure, the remaining amount of hydrogen in the hydrogen gas tank 40C may be calculated by the controller 23 from, for example, the measurement data of the pressure meter 44 provided in the hydrogen gas tank 40C. Alternatively, the remaining amount of hydrogen in hydrogen gas tank 40C may be calculated by a controller 23 from the measurement data of flowmeter 43 provided in the hydrogen gas path for supplying hydrogen gas from the hydrogen gas tank 40C to the fuel cell device 15. The measurement data of the pressure meter 44 or the flowmeter 43 may be transmitted to the controller 23 via a controller (not illustrated) provided in the fuel cell device 15 or may be transmitted directly to the controller 23. The controller (not illustrated) provided in the fuel cell device 15 corresponds to the control unit 30A or the like described below.

The above-described configurations of the hydrogen supply source of the fuel cell device 15 are only examples, and the configuration is not limited thereto. The hydrogen supply source may be configured such that the hydrogen gas tank having a low remaining amount of hydrogen can be replaced with a new hydrogen gas tank at an appropriate time.

### Operation

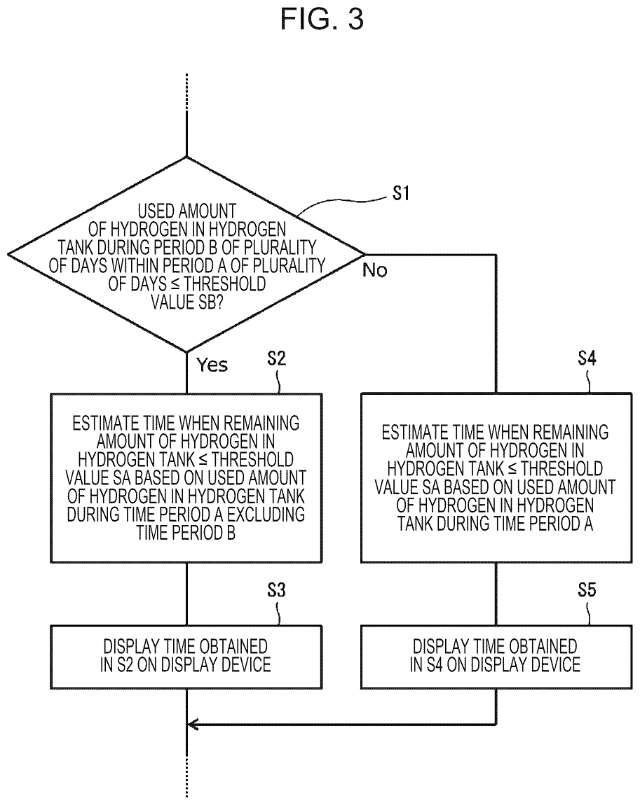

FIG. 3 is a flowchart of an example of the operations performed by the remaining amount estimation device for a hydrogen tank (a remaining amount estimation method for a hydrogen tank) according to the first embodiment. The operations described below may be performed by, for example, the arithmetic processing unit of the controller 23 that reads the control program from the storage unit of the controller 23. However, the operations described below are not necessarily performed by the controller 23. Some of the operations can be performed by an operator. In the examples described below, control of the operations is performed by the controller 23.

At a predetermined timing, a configuration file previously stored in the storage unit of the controller 23 is read into the arithmetic processing unit of the controller 23. The “predetermined timing” may be set to, but not limited to, at least once a week, for example. The “configuration file” stores, for example, the time period A and time period B preset by the user, and the type of hydrogen tank 40 (for example, a hydrogen gas tank or a liquid hydrogen tank). Data, such as the used amount of hydrogen in the hydrogen tank 40 during each of the time periods A and B is then retrieved from the storage unit of the controller 23.

After the above-described operations are performed, it is determined in step S1 whether the used amount of hydrogen in the hydrogen tank 40 during the time period B of a plurality of days within the time period A of a plurality of days is less than or equal to the threshold value SB.

The determination as to “whether the used amount of hydrogen in the hydrogen tank 40 during the time period B is less than or equal to the threshold value SB” made in step S1 is not limited to the determination made by comparing the total hydrogen usage of the hydrogen tank 40 during the time period B with the threshold value SB. For example, the “determination” in step S1 may be made by comparing the average value of the hydrogen usage of the hydrogen tank 40 during the time period B (for example, the average daily hydrogen usage) with the threshold value SB determined for the average value of the hydrogen usage of the hydrogen tank 40 during the time period B. Alternatively, the “determination” in step S1 may be made by comparing the average power generation output of the fuel cell unit, which is indirectly correlated to the hydrogen usage of the hydrogen tank 40 during the time period B, with the threshold value SB determined for the average power generation of the fuel cell unit during the time period B.

If the used amount of hydrogen in the hydrogen tank 40 during the time period B within the time period A is less than or equal to the threshold value SB (“Yes” in step S1), the time when the remaining amount of hydrogen in a hydrogen tank falls to the threshold value SA or below is estimated in step S2 based on the used amount of hydrogen in the hydrogen tank 40 during the time period A excluding the time period B.

Subsequently, in step S3, the information regarding the time when the remaining amount of hydrogen in the hydrogen tank 40 falls to the threshold value SA or below that is estimated in step S2 is notified to the display device 50 by the communicator 21. The time when the remaining amount of hydrogen in the hydrogen tank 40 falls to the threshold value SA or below may be provided to the user as the information in the year-month-day format on a calendar displayed on the display device 50. If the time when the remaining amount of hydrogen in the hydrogen tank 40 falls to the threshold value SA or below is stored in the storage unit of the controller 23, the stored time may be updated with new data. Thereafter, at the next predetermined timing, the operations in step S1 and the subsequent steps are performed again.

However, if the used amount of hydrogen in the hydrogen tank 40 during the time period B within the time period A is greater than the threshold value SB (“No” in step S1), the time when the remaining amount of hydrogen in a hydrogen tank falls to the threshold value SA or below is estimated in step S4 based on the used amount of hydrogen in the hydrogen tank during the time period A.

Subsequently, in step S5, the information regarding the time when the remaining amount of hydrogen in the hydrogen tank 40 falls to the threshold value SA or below that is estimated in step S4 is notified to the display device 50 by the communicator 21. The time when the remaining amount of hydrogen in the hydrogen tank 40 falls to the threshold value SA or below may be provided to the user as the information in, for example, the year-month-day format on a calendar displayed on the display device 50. If the time when the remaining amount of hydrogen in the hydrogen tank 40 falls to the threshold value SA or below is stored in the storage unit of the controller 23, the stored time may be updated with new data. Thereafter, at the next predetermined timing, the operations in step S1 and the subsequent steps are performed again.

According to the present embodiment described above, it is possible to estimate the time when the remaining amount of hydrogen in the hydrogen tank 40 used in the fuel cell device 15 falls to the threshold value SA or below more accurately than before.

More specifically, excluding, from the calculation of hydrogen usage, data obtained during the time period B during which the hydrogen usage of the hydrogen tank 40 is irregularly low as compared with normal hydrogen usage over a plurality of days can result in a more appropriate calculation of hydrogen usage than when the data is not excluded. Therefore, according to the present embodiment, by estimating the time when the remaining amount of hydrogen in the hydrogen tank 40 falls to the threshold value SA or below based on the used amount of hydrogen in the hydrogen tank 40 during the time period A excluding the time period B, the accuracy of the estimation can be improved as compared with the case where such excluded period is not provided in calculation of hydrogen usage. This allows the user to refill the hydrogen tank 40 or replace the hydrogen tank 40 in use with a new hydrogen tank in a timely manner.

In addition, according to the present embodiment, by setting each of the time period A and the time period B to a plurality of consecutive days, estimation of the time when the remaining amount of hydrogen in a hydrogen tank 40 falls to the threshold value SA or below is less affected by the fluctuation in hydrogen usage in daily activities. For example, in general, the amount of hydrogen used on a specific day, such as a holiday, is lower than that on a weekday. According to the present embodiment, by setting each of the time period A and the time period B in the above-described manner, the influence of fluctuation in daily hydrogen usage is reduced in the estimation of the time when the remaining amount of hydrogen in the hydrogen tank 40 falls to the threshold value SA or below.

### First Example

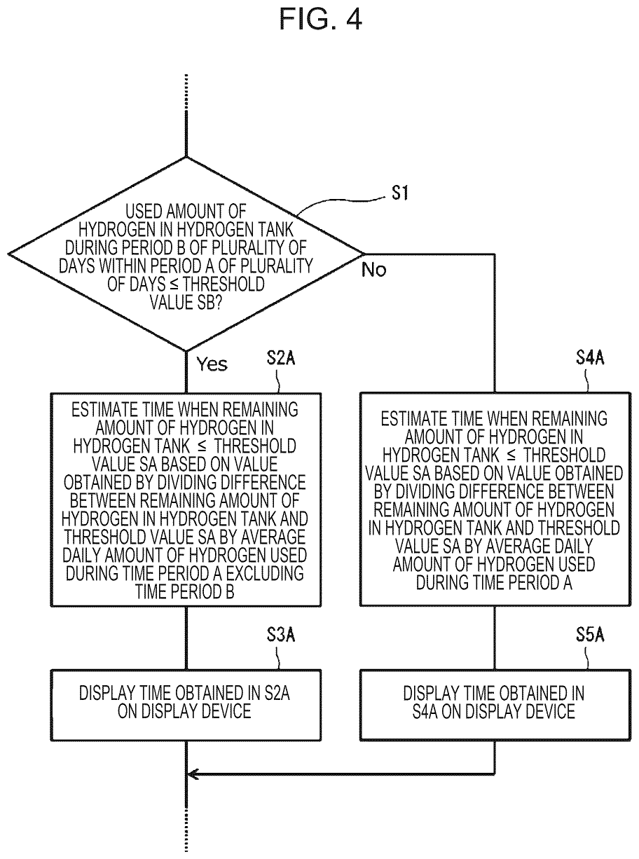

FIG. 4 is a flowchart illustrating an example of the operation performed by the remaining amount estimation device for a hydrogen tank (the remaining amount estimation method for a hydrogen tank) according to a first example of the first embodiment. The operations described below may be performed by, for example, the arithmetic processing unit of the controller 23 that reads the control program from the storage unit of the controller 23. However, the operations described below is not necessarily performed by the controller 23. Some of the operations can be performed by an operator. In the example described below, control of the operations is performed by the controller 23.

Step S1 in FIG. 4 is the same as step S1 in FIG. 3 and, thus, detailed description of step S1 is omitted.

If the used amount of hydrogen in the hydrogen tank 40 during the time period B within the time period A is less than or equal to threshold value SB (“Yes” in step S1), the time when the remaining amount of hydrogen in the hydrogen tank 40 falls to the threshold value SA or below is estimated in step S2A based on the value obtained by dividing the difference between the remaining amount of hydrogen in the hydrogen tank 40 and the threshold value SA by the average daily amount of hydrogen used during the time period A excluding the time period B.

For example, the average daily amount q1 of hydrogen used during the time period A excluding the time period B (hereinafter referred to as an “average hydrogen usage q1”) is calculated by the following Equation (1):

$$q 1 ( {Nm}^{3} ( normal cubic meter ) / day ) = ( total amount of hydrogen used during time period A excluding time period B ) / ( number of days in time period A - number of days in time period B ) . \qquad ( 1 )$$

Furthermore, a difference Q1 between the amount of hydrogen present in the hydrogen tank 40 and the amount of hydrogen corresponding to the threshold value SA can be obtained from the measurement data of, for example, the pressure meter 44 by using the following Equation (2):

$$Q 1 ( {Nm}^{3} ) = ( current measurement data ( MPa ) of pressure meter 44 - threshold value SA ( MPa ) ) \times “ predetermined coefficient ” . \qquad ( 2 )$$

Herein, the “predetermined coefficient” is a numerical value that is preset by the user and that is proportional to the size (volume) of the hydrogen tank 40 and is an appropriate value for converting the counting data from a sensor into the remaining amount of hydrogen in the hydrogen tank 40 (normal cubic meter).

Then, the number of days T1 until the remaining amount of hydrogen in the hydrogen tank 40 reaches the threshold value SA is estimated by using the following Equation (3):

$$T 1 ( days ) = Q 1 / q 1. \qquad ( 3 )$$

As described above, the time when the remaining amount of hydrogen in the hydrogen tank 40 falls to the threshold value SA or below can be estimated from the number of days T1 described above.

Subsequently, in step S3A, the information regarding the time when the remaining amount of hydrogen in the hydrogen tank 40 falls to the threshold value SA or below that is estimated in step S2A is notified to the display device 50 by the communicator 21. The time when the remaining amount of hydrogen in the hydrogen tank 40 falls to the threshold value SA or below may be provided to the user as, for example, the information in the year-month-day format on a calendar displayed on the display device 50. If the time when the remaining amount of hydrogen in the hydrogen tank 40 falls to the threshold value SA or below is stored in the storage unit of the controller 23, the stored time may be updated with new data. Thereafter, at the next predetermined timing, the operations in step S1 and the subsequent steps are performed again.

However, if the used amount of hydrogen in the hydrogen tank 40 during the time period B within the time period A is greater than the threshold value SB (“No” in step S1), the time when the remaining amount of hydrogen in the hydrogen tank 40 falls to the threshold value SA or below is estimated in step S4A based on a value obtained by dividing the difference between the remaining amount of hydrogen in the hydrogen tank 40 and the threshold value SA by the average daily amount of hydrogen used during the time period A.

For example, the average daily amount of hydrogen q2 used during the time period A (hereinafter referred to as an “average hydrogen usage q2”) is calculated by the following Equation (4):

$$q 2 ( {Nm}^{3} ( normal cubic meter ) / day ) = ( total amount of hydrogen used in time period A ) / \\ ( number of days in time period A ) . \qquad ( 4 )$$

Furthermore, a difference Q2 between the amount of hydrogen present in the hydrogen tank 40 and the amount of hydrogen corresponding to the threshold value SA can be obtained from the measurement data of, for example, the pressure meter 44 by using the following Equation (5):

$$Q 2 ( {Nm}^{3} ) = ( current measurement data ( MPa ) of pressure meter 44 - threshold value S A ( MPa ) ) \times “ predetermined coefficient ” . \qquad ( 5 )$$

Herein, the “predetermined coefficient” is a numerical value that is preset by the user and that is proportional to the size (volume) of the hydrogen tank 40 and is an appropriate value for converting the counting data from a sensor into the remaining amount of hydrogen in the hydrogen tank 40 (normal cubic meter).

Then, the number of days T2 until the remaining amount of hydrogen in the hydrogen tank 40 reaches the threshold value SA is estimated by using the following Equation (6):

$$T 2 ( days ) = Q 2 / q 2. \qquad ( 6 )$$

As described above, the time when the remaining amount of hydrogen in the hydrogen tank 40 falls to the threshold value SA or below can be estimated from the number of days T2 described above.

Subsequently, in step S5A, the information regarding the time when the remaining amount of hydrogen in the hydrogen tank 40 falls to the threshold value SA or below that is estimated in step S4A is notified to the display device 50 by the communicator 21. The time when the remaining amount of hydrogen in the hydrogen tank 40 falls to the threshold value SA or below may be provided to the user as, for example, the information in the year-month-day format on a calendar displayed on the display device 50. If the time when the remaining amount of hydrogen in the hydrogen tank 40 falls to the threshold value SA or below is stored in the storage unit of the controller 23, the stored time may be updated with new data. Thereafter, at the next predetermined timing, the operations in step S1 and the subsequent steps are performed again.

According to the present example described above, by estimating the time when the remaining amount of hydrogen in the hydrogen tank 40 falls to the threshold value SA or below based on the value obtained by dividing the difference between the remaining amount of hydrogen in the hydrogen tank 40 and the threshold value SA by the average daily amount of hydrogen used during the time period A excluding the time period B, the accuracy of the estimation can be improved as compared with the case where such excluded period is not provided in calculation of hydrogen usage.

The remaining amount estimation method for the hydrogen tank 40, the remaining amount estimation device 20 for the hydrogen tank 40, and the power generation system 10 according to the present example may be similar to those according to the first embodiment, except for the features described above.

### Second Example

The remaining amount estimation method for the hydrogen tank 40 according to the second example of the first embodiment is similar to the remaining amount estimation method for the hydrogen tank 40 according to the first embodiment, except that the time period A is one or more weeks, and the time period B is a week (weeks) less than or equal to the time period A.

According to the present example described above, by setting the time period A and the time period B to one or more weeks and a week (weeks) less than or equal to the first time period, respectively, the estimation of the time when the remaining amount of hydrogen in the hydrogen tank 40 falls to the threshold value SA or below is less affected by fluctuation in hydrogen usage in daily activities. For example, in general, the amount of hydrogen used during a specific time period in a week, such as a weekend (Saturday and Sunday), is lower than that on weekdays. According to the present example, by setting the time period A and the time period B in the above-described manner, the influence of fluctuation in weekly everyday hydrogen usage is reduced in estimation of the time when the remaining amount of hydrogen in the hydrogen tank 40 falls to the threshold value SA or below.

The remaining amount estimation method for the hydrogen tank 40, the remaining amount estimation device 20 for the hydrogen tank 40, and the power generation system 10 according to the present example may be similar to those according to the first embodiment or the first example of the first embodiment, except for the features described above.

### Modification

The remaining amount estimation method for a hydrogen tank 40 according to the modification of the first embodiment is similar to the remaining amount estimation method for the hydrogen tank 40 according to the first embodiment, except that when the time period A and the time period B are the same, the time when the remaining amount of hydrogen in the hydrogen tank 40 falls to the threshold value SA or below is not updated.

The statement “the time period A and the time period B are the same” means that the hydrogen usage of the hydrogen tank 40 during the entire time period A is irregularly less than the normal hydrogen usage. Therefore, according to the present modification described above, when the time period A and the time period B are the same, the time estimating operation can be performed more efficiently by not updating the time when the remaining amount of hydrogen in the hydrogen tank 40 used in the fuel cell device 15 falls to the threshold value SA or below.

The remaining amount estimation method for the hydrogen tank 40, the remaining amount estimation device 20 for the hydrogen tank 40, and the power generation system 10 according to the present modification may be similar to those according to any one of the first embodiment and the first and second examples of the first embodiment, except for the features described above.

### Second Embodiment

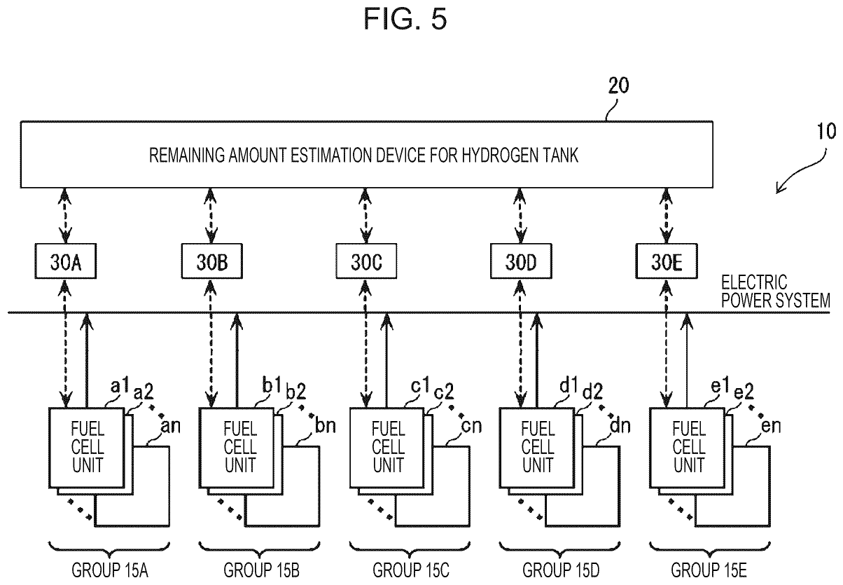

FIG. 5 illustrates an example of a power generation system according to the second embodiment. For convenience of description, the hydrogen tank 40 and the display device 50 according to the first embodiment (FIG. 1) are not illustrated in FIG. 5. The inner configuration of the remaining amount estimation device 20 for the hydrogen tank 40 is the same as that according to the first embodiment and, thus, detailed description of the inner configuration is omitted.

As illustrated in FIG. 5, the power generation system 10 according to the present embodiment includes groups 15A to 15E, which are provided by dividing fuel cell unit groups corresponding to the fuel cell device 15 (refer to FIG. 1), a remaining amount estimation device 20 for a hydrogen tank 40, and control units 30A to 30E. That is, the power generation system 10 includes fuel cell unit groups each consisting of a plurality of fuel cell units.

Although not illustrated, each of the fuel cell units includes a fuel cell stack, a DC-AC converter device for converting the DC power generated by the fuel cell stack into AC power and outputting the AC power to an electric power system, and a control unit for controlling the operations performed by the devices.

In the example illustrated in FIG. 5, the fuel cell unit groups are formed by fuel cell units a1 to an that belong to a group 15A, fuel cell units b1 to bn that belong to a group 15B, fuel cell units c1 to cn that belong to a group 15C, fuel cell units d1 to dn that belong to a group 15D, and fuel cell units e1 to en that belong to a group 15E. All of the fuel cell units that belong to one group are also simply referred to as a “fuel cell unit in the group”.

However, the above-described configuration of fuel cell unit groups is only an example and is not limited thereto. For example, the fuel cell unit groups may be formed by fuel cell units that belong to a single group. The number of fuel cell units in a group may be one.

The control units 30A to 30E are provided for the fuel cell units a1 to an in the group 15A, the fuel cell units b1 to bn in the group 15B, the fuel cell units c1 to cn in the group 15C, the fuel cell units d1 to dn in the group 15D, and the fuel cell units e1 to en in the group 15E, respectively, and control the operations performed by the fuel cell units in the groups.

For example, the control unit 30A controls the output of each of the fuel cell units a1 to an via a communication network so that the fuel cell units a1 to an in the group 15A can operate efficiently (for example, the lifetimes are optimized).

Any control unit having a control function can be used as each of the control units 30A to 30E. Each of the control units 30A to 30E includes an arithmetic processing unit (not illustrated), a storage unit that stores a control program, and a communicator. The arithmetic processing unit reads and executes the control program stored in the storage unit and, thus, performs predetermined control in the control units 30A to 30E. For example, a microprocessor is used as the arithmetic processing unit. For example, a memory is used as the storage unit.

The above configuration of the power generation system 10 is only an example and is not limited thereto.

For example, the fuel cell units may not include the control units, and the operations performed by the fuel cell units that belong to each of the groups may be directly controlled by one of the control units 30A to 30E.

The controller 23 (refer to FIG. 1) of the remaining amount estimation device 20 for the hydrogen tank 40 performs the operation to estimate the time when the remaining amount of hydrogen in the hydrogen tank 40 falls to the threshold value SA or below based on the amount of hydrogen in the hydrogen tank 40. However, the configuration is not limited thereto. A control unit other than the controller 23 (for example, each of the control units 30A to 30E) may perform the operation.

Furthermore, the remaining amount estimation device 20 for the hydrogen tank 40 may be integrated with the control units 30A to 30E, that is, may have the control functions of the control units 30A to 30E and directly control the operation performed by each of the fuel cell units in the group.

The remaining amount estimation method for the hydrogen tank 40, the remaining amount estimation device 20 for the hydrogen tank 40, and the power generation system 10 according to the present embodiment may be similar to those according to any one of the first embodiment, the first and second examples of the first embodiment, and the modification of the first embodiment, except for the features described above.

The first embodiment, the first and second example of the first embodiment, the modification of the first embodiment, and the second embodiment may be combined with one another as long as they do not exclude each other. From the above description, it will be appreciated by those skilled in the art that many improvements and other embodiments of the present disclosure could be made. Accordingly, the above description should be construed as an example only and is for the purpose of teaching those skilled in the art how best to practice the present disclosure. The details of the configuration and/or function can be substantially changed without departing from the spirit of the present disclosure.

An aspect of the present disclosure can be used in a remaining amount estimation method for a hydrogen tank, a remaining amount estimation device for a hydrogen tank, and a power generation system that can estimate the time when the remaining amount of hydrogen in a hydrogen tank used in a fuel cell device falls to a predetermined amount or below more accurately than existing ones.

What is claimed is:

1. A remaining amount estimation method for a hydrogen tank used in a fuel cell device including at least one fuel cell unit, comprising:
estimating a time when a remaining amount of hydrogen in the hydrogen tank falls to a first threshold value or below based on a used amount of hydrogen in the hydrogen tank during a first time period of a plurality of consecutive days; and
notifying a display device of the time,
wherein when a used amount of hydrogen in the hydrogen tank during a second time period of a plurality of consecutive days within the first time period is less than or equal to a second threshold value, the time is estimated based on a used amount of hydrogen in the hydrogen tank during the first time period excluding the second time period.

2. The remaining amount estimation method for a hydrogen tank according to claim 1, wherein if the first time period is the same as the second time period, the time is not updated.

3. The remaining amount estimation method for a hydrogen tank according to claim 1, wherein the time is estimated based on a value obtained by dividing a difference between the remaining amount of hydrogen in a hydrogen tank and the first threshold value by an average daily amount of hydrogen used during the first time period excluding the second time period.

4. The remaining amount estimation method for a hydrogen tank according to claim 1, wherein the first time period is one or more weeks, and the second time period is one week or weeks less than or equal to the first time period.

5. A remaining amount estimation device for a hydrogen tank used in a fuel cell device including at least one fuel cell unit, comprising:
a controller that estimates a time when a remaining amount of hydrogen in the hydrogen tank falls to a first threshold value or below based on a used amount of hydrogen in the hydrogen tank during a first time period of a plurality of consecutive days; and
a communicator that is controlled by the controller and that notifies a display device of the time,
wherein when a used amount of hydrogen in the hydrogen tank during a second time period of a plurality of consecutive days within the first time period is less than or equal to a second threshold value, the controller estimates the time based on a used amount of hydrogen in the hydrogen tank during the first time period excluding the second time period.

6. A power generation system comprising:
a fuel cell device including at least one fuel cell unit; and
the remaining amount estimation device for a hydrogen tank according to claim 5.
